(19) United States
(12) Patent Application Publication
(10) Pub. No.: US 2011/0303818 A1
(43) Pub. Date: Dec. 15, 2011

(54) LIFT STRUT WITH MECHANICAL SPRING ELEMENT

(75) Inventors: James W. Bach, Clinton, NY (US); Mark G. Tomandl, Cedar Springs, MI (US)

(73) Assignee: GRAND RAPIDS CONTROLS CO., LLC, Rockford, MI (US)

(21) Appl. No.: 13/157,405

(22) Filed: Jun. 10, 2011

Related U.S. Application Data
(60) Provisional application No. 61/353,378, filed on Jun. 10, 2010.

(51) Int. Cl. F16F 3/00; F16F 1/06; F16M 13/00; A47C 7/14

(52) U.S. Cl. 248/571; 267/166

(57) ABSTRACT

An extendable and retractable lift strut includes a support tube, a guide rod fixedly attached at the support tube, an extension tube that is extendable and retractable relative to the support tube and guide rod, and a biasing element that biases or urges the extension tube towards an extended position relative to the support tube. The biasing element may be a compression spring having a coiled wire formed of a shape memory alloy material. The biasing element provides a substantially constant biasing force over substantially the entire range of extension and retraction of the extension tube relative to the support tube. A locking mechanism may be disposed in the extension tube and may be selectively actuatable to lock relative to the guide rod to limit movement of the extension tube relative to the support tube.

### CROSS REFERENCE TO RELATED APPLICATION

The present application claims the filing benefit of U.S. provisional application Ser. No. 61/353,378, filed Jun. 10, 2010, which is hereby incorporated herein by reference in its entirety.

### FIELD OF THE INVENTION

The present invention relates generally to lift struts and, more particularly, lift struts for office chairs and the like; however, lift struts in accordance with the present invention are suitable for other applications.

### BACKGROUND OF THE INVENTION

Lift struts or cylinders are known for use in office chairs and the like to control the height setting of the chair. Typically, such lift cylinders include pressurized fluid (such as pressurized oil or pressurized gas or air or the like) therein to assist in raising and lowering the chair in a controlled manner. Such pressurized lift struts or cylinders are also typically used in other applications, such as for vehicle liftgates (such as for SUVs and minivans and the like) and/or vehicle hoods or decklids and/or adjustable height basketball poles and/or a variety of other applications where it is desired to control and assist the raising and lowering of an article or otherwise moving an article. Such pressurized lift cylinders often leak fluid or air or gas over time, which may result in decreased performance and may require periodic replacement of the strut or cylinder.

### SUMMARY OF THE INVENTION

The present invention provides a lift strut or cylinder that has a mechanical spring element to control the extension and retraction of the lift strut, with the mechanical spring element or biasing element having a substantially constant spring rate throughout its range of compression and extension. For example, the mechanical spring element or biasing element may comprise a shape memory alloy compression spring or coiled wire or the like (such as other material or materials that provide a substantially flat or constant spring rate throughout or substantially throughout the range of compression and extension of the material during use of the lift strut or cylinder). The lift strut of the present invention thus does not require pressurized fluid therein to control the raising and lowering of an article, such as a seat of an office chair or the like.

According to an aspect of the present invention, a lift strut (such as a lift strut suitable for incorporation in an office chair to raise and lower a seat height of the office chair) includes a support tube, an extension tube that is extendable and retractable relative to the support tube, and a mechanical biasing element that biases or urges the extension tube towards an extended position relative to the support tube. The biasing element comprises a material that provides a substantially constant biasing force or substantially constant spring rate over substantially the entire range of extension and retraction of the extension tube relative to the support tube (such as a shape memory alloy or the like).

Optionally, the extension tube may include a locking mechanism for selectively limiting movement of the extension tube relative to the support tube. Optionally, the extension tube includes a cushioning element to cushion or dampen initial movement of the extension tube relative to the support tube when the locking mechanism is locked.

Optionally, the biasing element may comprise a shape memory alloy material, and may comprise a compression spring comprising a coiled wire formed of the shape memory alloy material. Optionally, for example, the shape memory alloy material may comprise, for example, a nickel-titanium (NiTi) alloy, or may comprise a copper-zinc-aluminum-nickel alloy or a copper-aluminum-nickel alloy or other suitable shape memory material. Other materials that may provide a substantially constant or flat spring rate over substantially the entire range of extension and retraction of the extension tube relative to the support tube may be contemplated while remaining within the spirit and scope of the present invention.

Therefore, the present invention provides a lift strut that provides a substantially constant lifting force or resistance to compression over substantially the entire range of extension and retraction of the lift strut. The lift strut may be implemented in an office chair or the like, and provides a similar action or function as known gas springs or cylinders, but without any pressurized gas or fluid in the lift strut. Thus, the lift strut of the present invention provides enhanced performance and enhanced life cycles over conventional lift struts or cylinders or gas springs and obviates concerns with seal leakage and the like. Optionally, the lift strut of the present invention may be suitable for a wide range of applications.

These and other objects, advantages, purposes and features of the present invention will become apparent upon review of the following specification in conjunction with the drawings.

### BRIEF DESCRIPTION OF THE DRAWINGS

FIG. 1 is a side elevation of a lift strut in accordance with the present invention;

FIG. 2 is a sectional view of the lift strut taken along the line in FIG. 1;

FIG. 3 is a perspective view of the lift strut of the present invention, with the mounting tube and seat tube removed to show additional details; and

FIG. 4 is a perspective view of an office chair suitable for use with the lift strut of the present invention.

### DESCRIPTION OF THE PREFERRED EMBODIMENTS

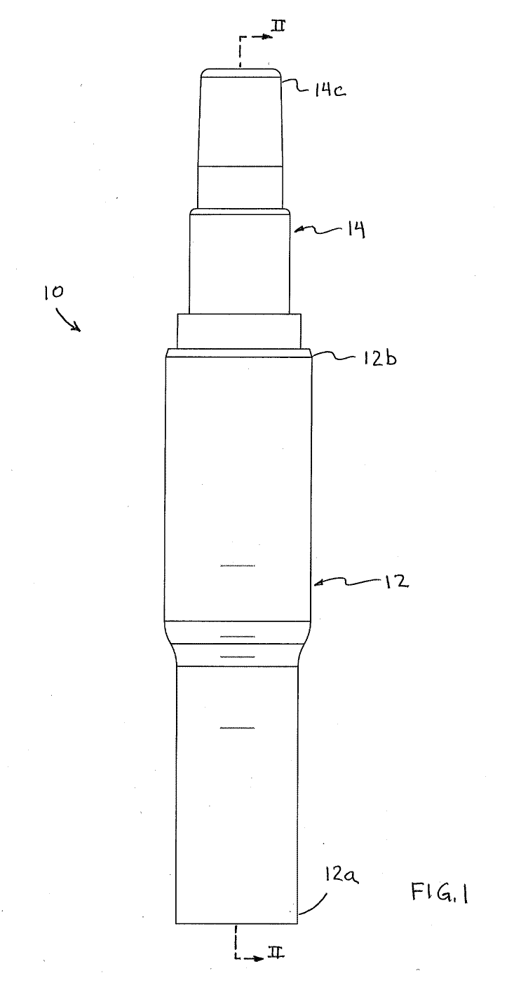

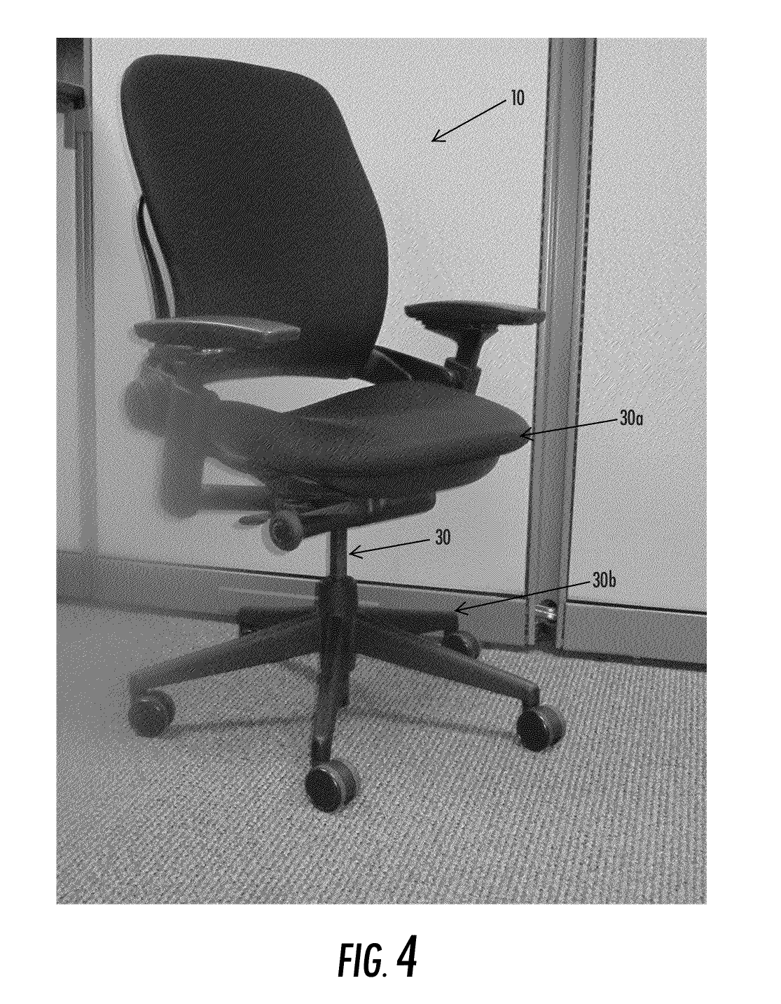

Referring now to the drawings and the illustrative embodiments depicted therein, a lift cylinder or lift strut 10 includes a support tube or mounting tube 12 and an extension tube or seat tube 14 that is extendable and retractable relative to support tube 12 via a mechanical biasing element or urging element 16, such as a compression spring or the like (FIGS. 1-3). Mechanical biasing element or compression spring 16 comprises a material that provides a substantially constant spring rate throughout its range of compression and extension. For example, the mechanical biasing element or compression spring 16 may comprise a coiled spring comprising a shape memory metal or alloy or other suitable material that provides such a substantially constant spring rate throughout or substantially throughout its range of compression and extension. The compression spring 16 thus provides a lifting function to selectively extend the extension tube 14 from the support tube 12, as discussed below. Lift strut 10 is suitable for various applications, such as, for example, application in an office chair 30 (FIG. 4), where the compression spring 16 may extend or urge the extension tube upwardly relative to the support tube to extend the extension tube 14 and elongate the lift strut to raise a seat height of the chair seat 30a relative to a base 30b of the chair 30, and may compress to allow retraction of the extension tube 14 to lower the seat height relative to the base of the chair. The biasing material or shape memory compression spring mimics the performance of a conventional pneumatic or fluid strut but without the problems of air or gas or fluid seal leakage associated with such known struts.

Support tube 12 and extension tube 14 comprise generally hollow tubes, with extension tube 14 being movably received within at least a portion of support tube 12. A guide element or guide rod 18 extends within support tube 12 and extension tube 14 and has an end 18a fixedly attached at an end wall 12a (such as the lower end wall or bottom) of support tube 12. A thrust washer 19 is disposed at the lower end 18a of guide rod 18 and at a narrowed portion of guide rod 18 to provide a larger diameter surface engagement between guide rod 18 and bottom wall 12a of support tube 12. Guide rod 18 may comprise any suitable elongated rod, such as a cylindrical metal rod or the like, and extends through support tube 12 and at least partially into and along extension tube 14.

Extension tube 14 has an inner end portion 14a that is configured to be received at and in or through an open end 12b of support tube 12 opposite end wall 12a. Inner end portion 14a of extension tube 14 receives guide rod 18 therethrough and extension tube 14 is movable along guide rod 18 relative to guide rod 18 and support tube 12. Extension tube 14 is selectively securable relative to guide rod 18 and support tube 12 (such as to set a desired seat height of a chair that incorporates lift strut 10) via a locking mechanism or lock unit 20.

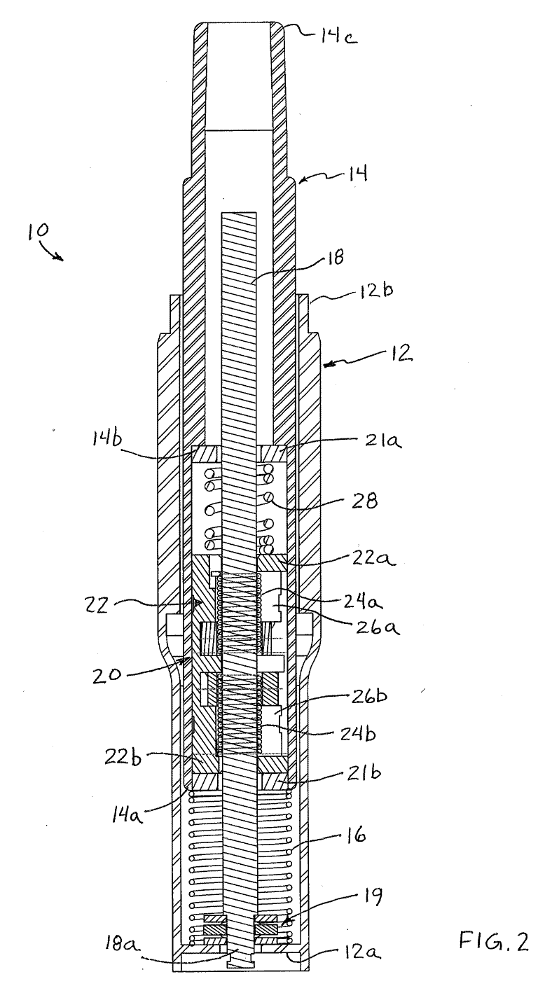

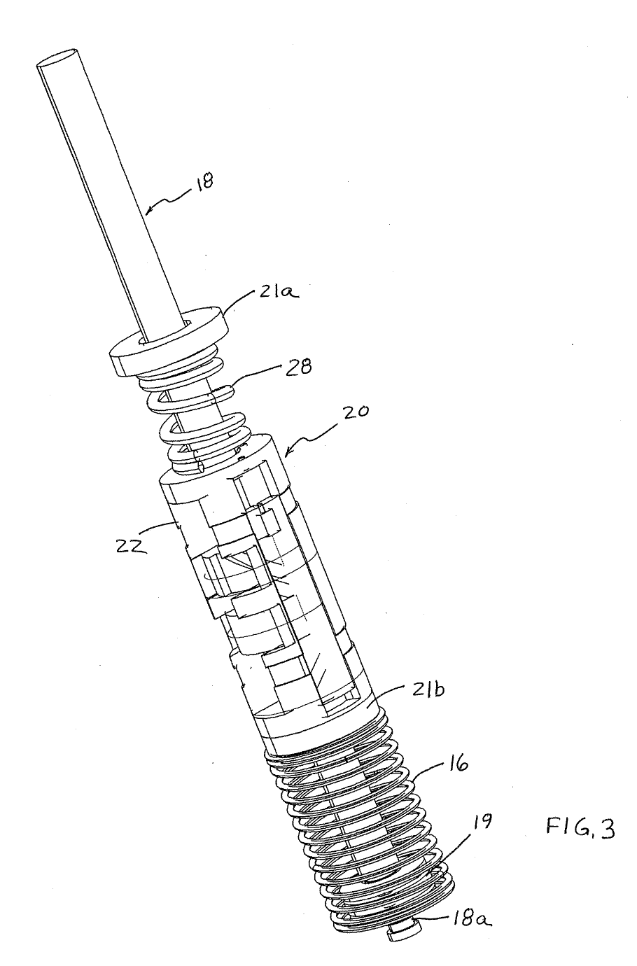

Locking mechanism or lock unit 20 may comprise any suitable locking mechanism that is selectively actuatable to clamp or secure to the guide rod 18 and/or extension tube 14 to limit or substantially preclude relative movement between the guide rod and extension tube. In the illustrated embodiment, locking mechanism 20 is received at the lower or inner end 14a of extension tube 14 and is operable (such as in response to a user input) to clamp onto the guide rod 18 to limit movement of extension tube 14 relative to guide rod 18 when the strut is at a desired or appropriate or selected degree of extension. As shown in FIGS. 2 and 3, a pair of lock unit collars 21a, 21b are disposed at opposite ends of locking mechanism 20 to provide or define the ends of a chamber in which locking mechanism 20 may move relative to the extension tube 14. Lock unit collar 21a is disposed at a step or flange 14b of extension tube 14 (and may be secured or fixed relative to the extension tube at the step or flange) to limit movement of collar 21a relative to extension tube 14, while lower collar 21b is disposed at a lower end of the locking mechanism 20 (and may be fixedly secured at the end 14a of extension tube 14) to limit movement of the locking mechanism in the downward direction to limit disassembly of the strut such as if the extension tube is pulled away from the support tube. Lock unit collars 21a, 21b thus mount or contain the locking mechanism 20 at the extension tube 14, while the locking mechanism allows for limited sliding movement of extension tube 14 along guide rod 18 between the lock unit collars.

In the illustrated embodiment, locking mechanism 20 comprises a retaining portion or housing or holder 22 that is disposed within extension tube 14 and between lock unit collars 21a, 21b and that is disposed at or near and is biased towards the inner end 14a of extension tube 14 and at lower or inner collar 21b. The locking mechanism 20 includes one or more locking springs or coil springs or torsion springs 24a, 24b that is/are wound around guide rod 18 and that is/are retained within the retaining portion 22. A pair of release mechanisms or spring rotators 26a, 26b are disposed at locking mechanism 20 and are selectively adjustable or actuatable by a user to rotate respective ends of the locking springs and/or to rotate retaining portion 22 of locking mechanism 20 about guide rod 18, in order to unwind or partially unwind or uncoil or expand the respective locking springs 24a, 24b, which expands the inner diameters of the locking springs 24a, 24b and reduces the clamping force applied by the locking springs 24a, 24b at the guide rod 18, thereby allowing for movement of locking mechanism 20 and extension tube 14 along guide rod 18.

In the illustrated embodiment, locking spring 24a is wound around the guide rod 18 in one direction while locking spring 24b is wound around the guide rod 18 in the opposite direction. Thus, actuation of and movement of the release mechanism 26a, 26b (attached at opposed or adjacent ends of the locking springs 24a, 24b, respectively, such as at the upper end of lower spring 24a and the lower end of upper spring 24b, respectively) in one direction unwinds both of the springs 24a, 24b together to allow for movement of the locking mechanism 20 and extension tube 14 along guide rod 18. When the release mechanisms 26a, 26b are released, the locking springs re-wind or coil tightly about the guide rod 18 to clamp around guide rod 18 and to secure the locking mechanism 20 and extension tube 14 relative to guide rod 18 at the desired or selected degree of extension of the lift strut.

In the illustrated embodiment, lift strut 10 includes a cushioning spring or element 28 that is disposed within extension tube 14 and around guide rod 18 and between the upper collar 21a and an upper end 22a of the lock mechanism retaining portion or housing or holder 22. Cushioning spring 28 comprises a coil spring that is compressible to provide a cushioning feel to a chair that incorporates the lift strut, such as when a person first sits on the seat of the chair. The cushioning spring 28 is disposed between the inner or upper end 22a of retaining portion 22 of locking mechanism 20 (opposite an outer or lower end 22b of retaining portion 22 that engages lower lock unit collar 21b at the inner or lower end portion 14a of extension tube 14) and lock unit collar 21a at the inner wall or flange or step 14b of extension tube 14. The compression spring or cushioning spring 28 thus allows for limited movement of extension tube 14 relative to guide rod 18 and support tube 12 when locking mechanism 20 is locked at guide rod 18. For example, when the locking mechanism is secured relative to guide rod 18 and a force is initially applied at extension tube 14 (such as when a person sits on a chair incorporating the lift strut), the cushioning spring 28 may compress or partially compress to allow for some movement of extension tube 14 relative to locking mechanism 20 and guide rod 18 (whereby locking mechanism 20 may move within extension tube 14 and away from lower lock unit collar 21b). The spring rate or force of cushioning spring 28 may be selected to provide the desired cushioning feel, and may provide a greater resistance to movement or compression as the cushioning spring is compressed, whereby the extension tube may be readily moved initially, but movement will be dampened by the increasing resistance or greater spring force as the cushioning spring is compressed.

Thus, when locking mechanism 20 is locked or clamped to guide rod 18 and a person sits on the seat or otherwise urges extension tube 14 toward or into support tube 12, cushioning spring 28 (and compression spring 16) may be compressed to allow extension tube 14 to move along guide rod 18 and support tube 12 and locking mechanism 20. When cushioning spring 28 is fully compressed or bottoms out, or is compressed as far as it will compress responsive to the weight or force exerted at extension tube 14, any further movement of extension tube relative to support tube will be limited or substantially precluded by locking mechanism 20 clamping onto guide rod 18. When it is desired to adjust the degree of extension of the lift strut, a user of the chair or strut may actuate the release mechanism 26a, 26b, such as via any suitable user input or lever that, responsive to movement of the lever or user input, imparts the appropriate rotational movement of the release mechanisms. When the release mechanisms 26a, 26b are actuated or rotated to release locking mechanism 20 (such as via a lever or the like that is accessible at an outer portion of the lift strut and that is actuatable by a user of the lift strut or chair), then further movement of extension tube 14 relative to support tube 12 may occur via further compression (or extension) of compression spring 16.

Compression spring 16 comprises a coiled spring or helical wound wire made up of a coiled shape memory wire, such as a shape memory wire comprising any suitable shape memory metal or alloy or the like. For example, compression spring 16 may comprise a shape memory alloy or smart metal or memory alloy or the like, such as nickel-titanium (NiTi) alloy, such as Nitinol (an acronym for Nickel Titanium Naval Ordnance Laboratories), or other shape memory alloy, such as copper-zinc-aluminum-nickel or copper-aluminum-nickel or other alloys of zinc, copper, gold, iron, nickel and/or titanium or the like. Such a shape memory alloy, when formed as a wire and coiled to form a coiled spring or helical shape, provides a substantially constant spring rate over substantially its entire range of compression and extension. Thus, the extension force imparted by the compression spring 16 is similar or substantially the same when the extension tube is at its fully extended position and when the extension tube is at its fully retracted position relative to the support tube. This allows the extension tube to be fully retracted with about the same amount of weight on or force at the supported seat as the weight or force that is needed to initially retract the extension tube from its fully extended state (when the locking mechanism is released and a person sits on or otherwise pushes down on the seat of the chair).

Accordingly, and as shown in the illustrated embodiment, the lift strut 10 is suitable for use in an office chair to raise and lower a seat height of the office chair in a controlled manner. For example, the support tube 12 may be mounted to a chair base (such as a roller base or the like) and the upper or outer end 14c of the extension tube 14 may be mounted to or attached to an underside of a seat portion of the chair (and may be pivotally mounted to allow for pivoting or swiveling of the seat about a generally vertical pivot axis relative to lift strut 10). The release mechanism may include a user actuatable tab or element or lever that extends from the lift strut (or is otherwise accessible to a person sitting on the seat of the chair), whereby a user can readily release the locking mechanism to facilitate adjustment of the height of the seat (via compression or extension of the compression spring). The shape memory alloy compression spring provides substantially uniform and controlled movement of the seat relative to the base throughout the range of extension and retraction of the extension tube relative to the support tube. The wire diameter or properties of the compression spring, and thus the biasing force provided by the compression spring, may be selected to allow for compression of the spring in response to a relatively low weight or force being applied to the seat (such as a weight of about ninety pounds or thereabouts), while providing sufficient resistance to compression to provide controlled raising and lowering of the seat.

Although discussed above as being applicable to office chairs and the like, it is envisioned that aspects of the lift strut of the present invention are suitable for many other applications where conventionally a gas strut or gas spring or cylinder or pneumatic cylinder or the like has been used. For example, a lift strut in accordance with the present invention (comprising a shape memory compression spring or the like) may be suitable for use on a vehicle, such as for a lift gate opening/closing device or a hood opening/closing device or a trunk or deck lid opening/closing device or the like, or may be suitable for use on door closure devices or basketball hoop adjustment devices or the like. In such outdoor or exterior applications (where the lift strut may be exposed to extreme temperatures, such as high and low temperatures), the lift strut of the present invention may provide enhanced performance over conventional gas springs and the like because the performance or spring rate or force of the shape memory alloy compression spring of the lift strut may be substantially consistent over a wide range of temperatures (unlike conventional gas springs, which may be more difficult to compress in high temperature environments, sometimes resulting in difficulties in closing a lift gate or the like, and may be easier to compress in low temperature environments, sometimes resulting in failure of the gas spring to support a lift gate in an open position).

Therefore, the lift strut of the present invention provides a substantially constant or uniform lifting force or resistance to compression force over substantially the entire range of extension and retraction of the lift strut, and may do so over a wide range of temperatures. The lift strut may be implemented in a chair, such as an office chair or the like, and provides a similar action or function as known gas springs or cylinders, but without any pressurized gas or fluid in the lift strut. Thus, the lift strut of the present invention provides enhanced performance and enhanced life cycles over conventional lift cylinders or struts or gas springs and obviates concerns with seal leakage and the like. Optionally, a lift strut incorporating a shape memory compression spring or other substantially flat or constant rate spring or biasing device or mechanism or the like in accordance with the present invention may be suitable for a wide range of applications, while remaining within the spirit and scope of the present invention.

Changes and modifications to the specifically described embodiments may be carried out without departing from the principles of the present invention, which is intended to be limited only by the scope of the appended claims, as interpreted according to the principles of patent law.

1. A lift strut that is extendable and retractable, said lift strut comprising:
a support tube;
an extension tube that is extendable and retractable relative to said support tube; and
a biasing element that biases or urges said extension tube towards an extended position relative to said support tube, wherein said biasing element provides a substantially constant biasing force over substantially the entire range of extension and retraction of said extension tube relative to said support tube.

2. The lift strut of claim 1, wherein said extension tube is movable along a guide rod attached to and extending within said support tube.

3. The lift strut of claim 2, wherein said extension tube includes a locking mechanism for selectively locking relative to said guide rod to limit movement of said extension tube relative to said support tube.

4. The lift strut of claim 3, wherein said extension tube includes a cushioning element to cushion or dampen initial movement of said extension tube relative to said support tube when said locking mechanism is locked relative to said guide rod.

5. The lift strut of claim 3, wherein said locking mechanism comprises a coiled element that is coiled around said guide rod and is rotated in one direction to expand its diameter and release said guide rod and rotated in the opposite direction to contract its diameter to clamp onto said guide rod.

6. The lift strut of claim 1, wherein said biasing element comprises a compression spring comprising a material that provides a substantially constant biasing force over substantially the entire range of extension and retraction of said extension tube relative to said support tube.

7. The lift strut of claim 1, wherein said biasing element comprises a shape memory alloy material.

8. The lift strut of claim 7, wherein said biasing element comprises a compression spring comprising a coiled wire formed of said shape alloy material.

9. The lift strut of claim 7, wherein said shape alloy material comprises one of a nickel-titanium alloy, a copper-zinc-aluminum-nickel alloy and a copper-aluminum-nickel alloy.

10. The lift strut of any claim 1, wherein said lift strut is incorporated in an office chair to raise and lower a seat height of the office chair.

11. A lift strut that is extendable and retractable, said lift strut comprising:
a support tube;
a guide rod fixedly attached at said support tube and extending at least partially along said support tube;
an extension tube that is extendable and retractable relative to said support tube and said guide rod;
a biasing element that biases or urges said extension tube towards an extended position relative to said support tube, wherein said biasing element comprises a compression spring comprising a coiled wire formed of a shape memory alloy material, and wherein said biasing element provides a substantially constant biasing force over substantially the entire range of extension and retraction of said extension tube relative to said support tube;
a locking mechanism disposed in said extension tube and selectively actuatable to lock relative to said guide rod to limit movement of said extension tube relative to said support tube.

12. The lift strut of claim 11, wherein said shape alloy material comprises one of a nickel-titanium alloy, a copper-zinc-aluminum-nickel alloy and a copper-aluminum-nickel alloy.

13. The lift strut of claim 11, wherein said extension tube includes a cushioning element to cushion or dampen initial movement of said extension tube relative to said support tube when said locking mechanism is locked relative to said guide rod.

14. The lift strut of claim 13, wherein said locking mechanism comprises a coiled element that is coiled around said guide rod and is rotated in one direction to expand its diameter and release said guide rod and rotated in the opposite direction to contract its diameter to clamp onto said guide rod.

15. The lift strut of any claim 11, wherein said lift strut is incorporated in an office chair to raise and lower a seat height of the office chair.
